(19) United States
(12) Patent Application Publication
(10) Pub. No.: US 2025/0379944 A1
(43) Pub. Date: Dec. 11, 2025

(54) IMAGE FORMING APPARATUS

(71) Applicant: CANON KABUSHIKI KAISHA, Tokyo (JP)

(72) Inventor: KEITA YAMAMOTO, Chiba (JP)

(21) Appl. No.: 19/225,865

(22) Filed: Jun. 2, 2025

(30) Foreign Application Priority Data
Jun. 7, 2024 (JP) 2024-092977

(51) Int. Cl. H04N 1/00

(52) U.S. Cl. CPC H04N 1/00307; H04N 1/00557; H04N 2201/006

(57) ABSTRACT

An image forming apparatus includes an image forming unit, an apparatus body, an operation unit that includes a display unit, a door that includes an exterior surface constituting part of a front side of the apparatus body on a lower side of the operation unit, and a wireless communication unit configured to receive data from a portable information device via near field wireless communication in response to the portable information device being presented. In a case where a lateral direction is a direction perpendicular to the front-back direction of the image forming apparatus and a vertical direction, the wireless communication unit is arranged above the door to align with the operation unit in the lateral direction, and a front edge of the wireless communication unit in the front-back direction projects forward beyond the exterior surface of the door which is in the closed position.

### BACKGROUND

### Field of the Technology

This disclosure relates to an image forming apparatus, such as a printer, a copier, a facsimile, a multifunction machine, or the like.

### Description of the Related Art

Hitherto, for example, in order to prevent information leakage due to the removal of printed materials, or to manage the usage of apparatuses, an image forming apparatuses that withholds performing image forming operations to form images on recording materials until a user performs personal verification with an integrated circuit (IC) card is suggested (Japanese Patent Laid-Open No. 2012-210801). However, since there are certain installation personnel who do not necessitate personal verification functions, the image forming apparatuses are configured such that IC card readers for reading data from IC cards through wireless communication can be optionally mounted. In the image forming apparatus described in Japanese Patent Laid-Open No. 2012-210801, an installation space is secured adjacent to an operation panel where it is easy to present an IC card, and an IC card reader is mounted in that installation space.

Incidentally, there is a growing demand for the further miniaturization of the image forming apparatuses, and there is a trend toward miniaturizing apparatus bodies to further reduce occupied areas of the image forming apparatuses. In such a case, since the installation spaces for mounting the IC card readers are reduced as the apparatus bodies are further miniaturized, it is difficult to mount the IC card readers of existing dimensions. Accordingly, while it is conceivable to install smaller IC card readers to align with reduced installation spaces, since the IC card readers are optional devices, providing various sizes of IC card readers is difficult to adopt due to cost constraints. In addition, while it is also conceivable to secure the installation spaces at other locations away from the operation units, it is difficult to adopt because the user may encounter difficulty in presenting the IC cards efficiently.

### SUMMARY

According to some embodiments, an image forming apparatus includes an image forming unit configured to form an image on a recording material, an apparatus body configured to store the image forming unit, an operation unit that includes a display unit configured to display information relating to image formation and is configured to receive a user input operation, a door that includes an exterior surface constituting part of a front side of the apparatus body on a lower side of the operation unit in a case where the front side is a side facing a user during an operation of the operation unit in a front-back direction, the door being configured to move between a closed position and an open position in which the user is allowed access to an interior of the apparatus body, and a wireless communication unit configured to receive data from a portable information device via near field wireless communication in response to the portable information device being presented. In a case where a lateral direction is a direction perpendicular to the front-back direction of the image forming apparatus and a vertical direction, the wireless communication unit is arranged above the door to align with the operation unit in the lateral direction, and a front edge of the wireless communication unit in the front-back direction projects forward beyond the exterior surface of the door which is in the closed position.

Features of the present disclosure will become apparent from the following description of embodiments with reference to the attached drawings. The following description of embodiments are described by way of example.

### BRIEF DESCRIPTION OF THE DRAWINGS

FIG. 1 is a perspective view illustrating an image forming apparatus of this embodiment.

FIG. 2 is a schematic diagram illustrating the image forming apparatus.

FIG. 3 is an exploded perspective view illustrating a wireless communication unit.

FIG. 4 is a schematic diagram illustrating a mechanism of wireless communication with an IC card via an IC card reader.

FIG. 5 is a perspective view illustrating an IC card reader storage portion.

FIG. 6 is a top view illustrating an operation unit and the wireless communication unit.

FIG. 7 is a side view illustrating the operation unit and the wireless communication unit.

### DESCRIPTION OF THE EMBODIMENTS

### Image Forming Apparatus

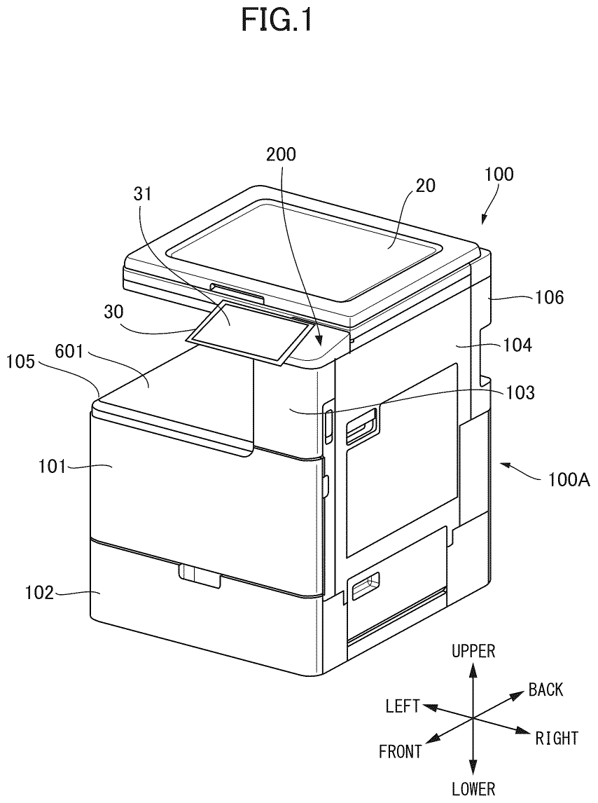

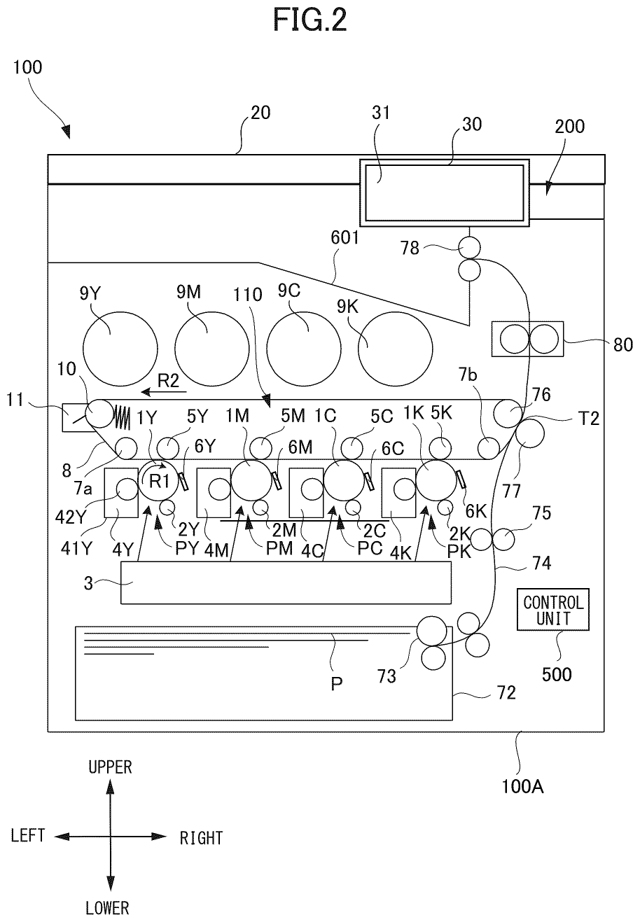

Hereinafter, various exemplary embodiments, features, and aspects will be described with reference to the drawings. Using FIGS. 1 and 2, an image forming apparatus of the present embodiment will be described. In FIGS. 1 and 2, an in-body discharge type image forming apparatus 100 is illustrated as an example. The image forming apparatus 100 includes an apparatus body 100A and a document reading apparatus 20 that reads image information of a document, and a sheet discharge tray 601 that supports a recording material discharged from the apparatus body 100A is disposed between the apparatus body 100A and the document reading apparatus 20. The recoding material includes various types of sheet materials, such as paper sheets, which encompass standard paper, thick paper, rough paper, embossed paper, coated paper, and the like, plastic films, and cloth.

As illustrated in FIG. 2, the image forming apparatus 100 includes an image forming unit 110. The image forming unit 110 is housed within the apparatus body 110A, and forms a toner image on a recording material P based on an image signal transmitted from the document reading apparatus 20 or an external device (not shown) such as a personal computer. To be noted, in this embodiment, the image forming unit 110 that forms the toner image on the recording material P includes image forming stations PY to PK, primary transfer rollers 5Y to 5K, an intermediate transfer belt 8, a tension roller 10, a secondary transfer inner roller 76, and stretch rollers 7a and 7b, and a secondary transfer outer roller 77, described below.

A conveyance process of the recording material P in the image forming apparatus 100 will be described. As illustrated in FIG. 2, the recording P is stored in a stacked form within a cassette 72, and is supplied to a conveyance path 74 one sheet at a time by a supply roller 73 in synchronization with the timing of image formation. In addition, the recording material P stacked on a manual feed tray, not shown, may be supplied to the conveyance path 74 one sheet at a time. When the recording material P is conveyed to a registration roller pair 75 arranged midway along the conveyance path 74, after performing the skew correction and a timing adjustment of the recording material P by the registration roller 75, the recording material P is sent to a secondary transfer portion T2. The secondary transfer portion T2 is a transfer nip portion formed by the secondary transfer inner and outer rollers 76 and 77 that are arranged to face each other. In the secondary transfer portion T2, by applying a secondary transfer voltage to the secondary transfer inner roller 76, the toner image is transferred from the intermediate transfer belt 8 onto the recording material P.

An image forming process of the image, which is delivered to the secondary transfer portion T2 in a similar timing with respect to the conveyance process of the recording material P to the secondary transfer portion T2 described above, will be described. First, the image forming stations PY, PM, PC, and PK will be described. However, the image forming stations PY to PK are configured almost identically except for a difference in toner colors used by developing units 4Y, 4M, 4C, and 4K, which are yellow, magenta, cyan, and black. Therefore, hereinafter, the image forming station PY will be described as a representative example, and the description of the other image forming stations PM, PC, and PK will be omitted. To be noted, for illustration purposes, a developing container 41Y and a developing roller 42Y, described below, are only annotated in the image forming station PY.

The image forming station PY primarily includes a photosensitive drum 1Y, a charge unit 2Y, the developing unit 4Y, a photosensitive drum cleaner 6Y, and the like. A surface of the photosensitive drum 1Y that is rotatably driven in an arrow R1 direction in FIG. 2 is uniformly charged by the charge unit 2Y beforehand, and, thereafter, an electrostatic latent image is formed by an exposure unit 3 that is driven based on a signal of the image information. Next, the electrostatic latent image formed on the photosensitive drum 1Y is converted into a visual image through toner development by the developing unit 4Y. The developing unit 4Y includes the developer container 41Y, which stores developer, and the developing roller 42, which rotates while bearing the developer, and, by applying a developing voltage to the developing roller 42Y, develops the electrostatic latent image into the toner image. Thereafter, a predetermined pressure force and a primary transfer voltage are applied by the primary transfer roller 5Y arranged to face the image forming station PY across the intermediate transfer belt 8, and the toner image formed on the photosensitive drum 1Y is primarily transferred onto the intermediate transfer belt 8. Transfer residual toner slightly remained on the photosensitive drum 1Y after the primary transfer is collected by the photosensitive drum cleaner 6Y.

Toner bottles 9Y, 9M, 9C, and 9K storing replenishment toner for replenishing the developing units 4Y to 4K are detachably disposed above the intermediate transfer belt 8. From the toner bottles 9Y to 9K, the toners of each color are replenished in a timely and appropriate quantity to the corresponding developing units 4Y to 4K through a toner replenishment mechanism.

The intermediate transfer belt 8 is stretched by the tension roller 10, the secondary transfer inner roller 76, and the stretch rollers 7a and 7b, and is driven to move in an arrow R2 direction in FIG. 2. Image forming processes for each color, conducted by the image forming stations PY to Pk described above, are performed with timing that ensures a sequential overlap of the toner image onto an upstream toner image, in a moving direction, that has been primarily transferred onto the intermediate transfer belt 8. As a result, finally, a full color toner image is conveyed to the secondary transfer portion T2 while being borne on the intermediate transfer belt 8. To be noted, residual toner remaining after passing through the secondary transfer portion T2 is collected from the intermediate transfer belt 8 by a belt cleaner 11.

With the conveyance process and the image forming process each described above, the timing of the recording material P and the full color toner image is aligned at the secondary transfer portion T2, and the toner image is secondarily transferred onto the recording material P. Thereafter, the recording material P is conveyed to a fixing unit 80, and heat and pressure are applied by the fixing unit 80, so that the toner image is fixed on the recording material P. The recording material P on which the toner image has been fixed as described above is discharged to the sheet discharge tray 601 by a sheet discharge roller 78.

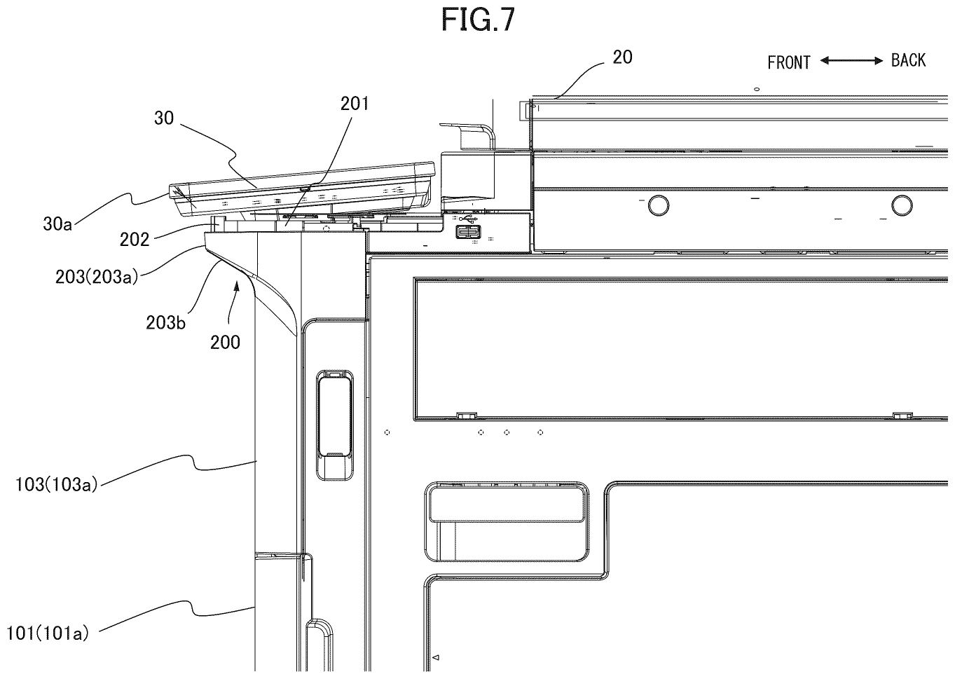

The apparatus body 100A includes a front-side plate disposed on a front side of the image forming apparatus 100, a back-side plate disposed on a back side, struts (frames) that support the front-side and the back-side plates, connection stays, and the like, and is covered by a plurality of exterior covers that constitute part of an exterior of the image forming apparatus 100. As illustrated in FIG. 1, a front cover 101, a cassette cover 102, and a front upper cover 103 are arranged on the front side. The front cover 101 is arranged on top of the cassette cover 102, and the front upper cover 103 is arranged on top of the front cover 101. In addition, side covers 104 and 105 are arranged on left and right side surfaces, and, further, a back-side cover 106 is arranged on the back side. To be noted, the front cover 101, the cassette cover 102, and the front upper cover 103 are arranged to prevent any from projecting forward to create a ledge. That is, each of their external surfaces is substantially aligned to form a continuous plane when viewed from a lateral direction. In addition, in other words, an exterior surface 101a (refer to FIG. 7), which constitutes the exterior surface (front surface) of the front cover 101, can also be regarded as constituting part of the front side of the apparatus body 100A below the operation unit 30, described below.

In this embodiment, the front cover 101 is a door that allows a user to access to the image forming unit 110 (refer to FIG. 2) within the apparatus body 100A (inside the apparatus body) from the outside and disposed to be openable and closable with respect to the apparatus body 100A. That is, the front cover 101 is configured to be movable between a closed position, in which an exterior surface 101a becomes part of the front surface of the apparatus body 100A, and an open position, in which the user can access to the interior of the apparatus body. By opening the front door 101, the user can perform the replacement, maintenance, and the like of the photosensitive drums, the developing units, or the toner bottles, described below.

As illustrated in FIGS. 1 and 2, the image forming apparatus 100 includes an operation unit 30. The operation unit 30 is arranged on a side of the front cover 101 (on a side of the door) in the apparatus body 100A, and is located above the front cover 101 and more forward than the document reading apparatus 20. The operation unit 30 is disposed on the apparatus body 100A such that, using a tilting mechanism or the like for angular adjustment, the operation unit 30 can tilt within a range of “53 degrees to 85 degrees” in the vertical direction with respect to a reference horizontal plane (0 degrees), and can pivot in the vertical direction with the lateral direction as a pivot axis direction. In addition, the operation unit 30 is disposed further to the right than a center of the apparatus body 100A in the lateral direction.

To be noted, in this disclosure, a side on which the user stands with respect to the apparatus body 100A when operating the operation unit 30 is referred to as the “front (front side)”, and the opposite side is referred to as “back”. In addition, the left side when viewing the image forming apparatus 100 from the front side is referred to as the “left”, and the right side when viewing the image forming apparatus 100 from the front side is referred to as the “right”.

The user can perform an input operation relating to the image formation from the operation unit 30. As an example, the operation unit 30 is a touch panel that includes a liquid crystal display screen 31, serving as a display unit, capable of displaying a software key on the liquid crystal display screen 31 and capable of accepting the user input operation of information relating to the image formation through a touch operation onto the displayed software key. The information relating to the image formation includes, for example, settings for the size and the number of recording materials on which the image formation is performed, an execution instruction for the image forming job, and various conditions and control commands when instructing the image forming apparatus 100 to perform the image forming operation.

Further, as illustrated in FIG. 2, the image forming apparatus 100 includes a control unit 500, and the control unit 500 is disposed in the interior of the apparatus body 100A. The control unit 500 performs various control on the image forming apparatus 100, such as the image forming operation, and, while illustration is omitted, includes a central processing unit (CPU), a read only memory (ROM), a random access memory (RAM), and the like. The ROM stores various programs and data for the control of the image forming apparatus 100. The CPU can execute the various programs stored in the ROM, and operates the image forming apparatus 100 by executing the various programs. The RAM temporarily stores arithmetic processing results, data, and the like generated in conjunction with the execution of the various programs. The control unit 500 executes the various programs such as the “image forming job”, and adjusts various data settings in accordance with the touch operation of the user onto the operation unit 30, and the like.

### Wireless Communication Unit

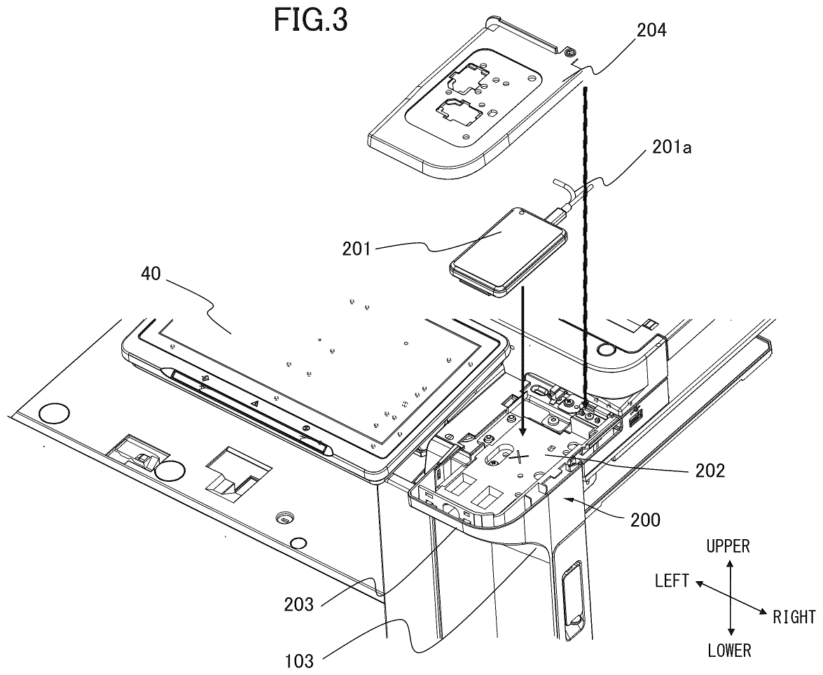

Also in this embodiment, as already described, to prevent information leakage due to the removal of printed documents and to manage the usage of the apparatus, until the user performs user verification using an integrated circuit (IC) card, the image forming apparatus 100 does not perform the image formation to output the image on the recording material P. To ensure this functionality, the image forming apparatus 100 includes a wireless communication unit 200 that acquires data from an IC card 300, serving as a portable information device. A configuration of the wireless communication unit 200 will be described using FIGS. 3 to 5.

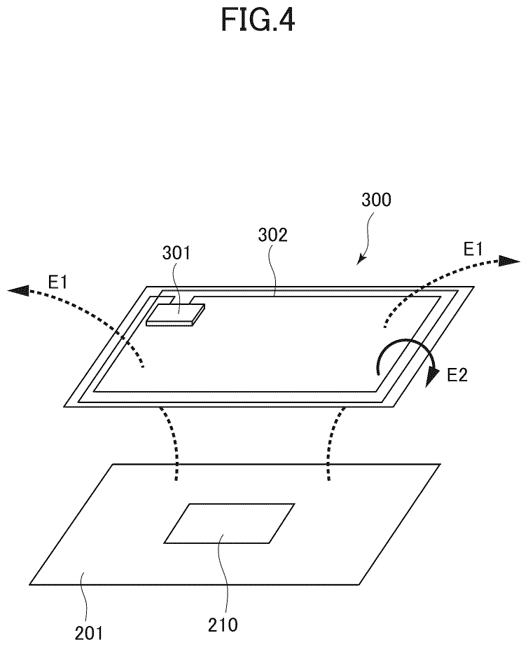

As illustrated in FIG. 3, the wireless communication unit 200 includes a contactless type IC card reader 201, an IC card reader storage portion 202 that stores the IC card reader 201, and a supporting portion 203 that supports the IC card reader storage portion 202. The IC card reader 201, serving as an acquisition unit, engages in wireless communication with the IC card 300 (refer to FIG. 4) when the IC card 300 is presented by the user, and acquires data from the IC card 300. The data acquired from the IC card 300 includes information for the personal verification, such as user identification (ID). The IC card reader 201 is the wireless communication device that performs NFC communication, which is near field wireless communication, with the IC card 300. NFC refers to a contactless wireless communication standard that utilizes an electromagnetic wave at 13.56 megahertz (MHz).

Here, a mechanism of the wireless communication with the IC card 300 by the IC card reader 201 will be described. As illustrated in FIG. 4, the IC card reader 201 includes an antenna portion 210 that performs the transmission and reception of the electromagnetic wave. In this embodiment, when the main power of the image forming apparatus 100 is activated, power is supplied to the IC card reader 201, and the antenna portion 210 emits a magnetic field E1. On the other hand, the IC card 300 includes an IC chip 301 and a coil 302. In a state in which the IC card 300 is presented to the IC card reader 201, a magnetic field E2 is generated in the coil 302 by the magnetic field E1 emitted by the antenna portion 210, and an induced current flows in the coil 302. In the IC card 300, the IC chip 301, which controls the NFC communication, is activated by the induced current that flows in the coil 302, and the wireless communication is performed between the IC chip 301 and the IC card reader 201. The wireless communication between the IC chip 301 and the IC card reader 201 is performed when a distance between the IC card 300 and the IC card reader 201 is equal to or less than a predetermined distance (for example, equal to or less than 30 millimeters (mm)). Therefore, the state in which the IC card 300 is presented to the IC card reader 201 is a state in which the distance between the IC card 300 and the IC card reader 201 is equal to or less than the predetermined distance.

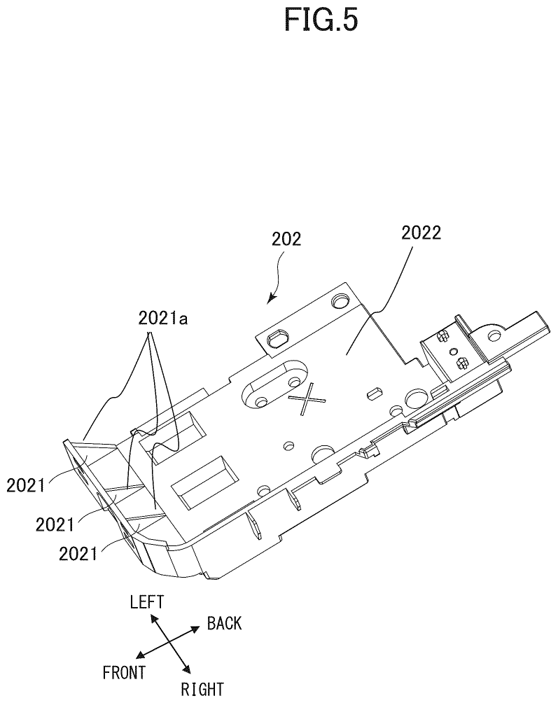

Returning to FIG. 3, the IC card reader 201 is stored in the IC card reader storage portion 202. The IC card reader storage portion 202 is provided to allow for the optional and convenient mounting of the IC card reader 201 when desired. As illustrated in FIG. 5, a plurality of ribs 2021 are formed to align laterally on the front side of the IC card reader storage portion 202. These ribs 2021 include an inclined surface 2021a whose height from a bottom surface 2022 decreases from the front side toward the back side. The IC card reader 201, when stored in the IC card reader storage portion 202, is slid from the front side to the back side following the inclined surface 2021a of the rib 2021, and is guided to a predetermined storage position in the IC card reader storage portion 202.

In addition, as illustrated in FIG. 3, a storage cover 204, serving as a cover member, is disposed in an openable and closable manner in the IC card reader storage portion 202. In a case where the IC card reader 201 is mounted as an option, by opening the storage cover 204, the IC card reader 201 is stored in the IC card reader storage portion 202. Then, a universal serial bus (USB) cable 201a provided to the IC card reader 201 is connected to the control unit 500 (refer to FIG. 2) within the apparatus body 100A via a connector in a manner capable of transmitting and receiving the data. Thereby, the data such as the user ID read from the IC card 300 by the IC card reader 201 is transmitted to the control unit 500. In a case of having received the user ID, the control unit 500 performs the personal verification based on the received user ID, and controls the image forming apparatus 100 to selectively execute the image forming operation with respect to the image forming job whose execution is instructed by the personally verified user.

By closing the storage cover 204 with the IC card reader 201 stored in the IC card reader storage portion 202, the IC card reader 201 is hidden from the sight of the user, and, thereby, an appearance of the image forming apparatus 100 is improved. To be noted, since, in the closed state, the storage cover 204 covers the IC card reader 201 stored in the IC card reader storage portion 202, it is preferred to display a mark or the like on the storage cover 204 to indicate to the user a position for presenting the IC card 300. Alternatively, a window made of transparent material may be disposed so as to allow the user to visually confirm from the outside whether or not the IC card reader 201 is stored in the IC card reader storage portion 202.

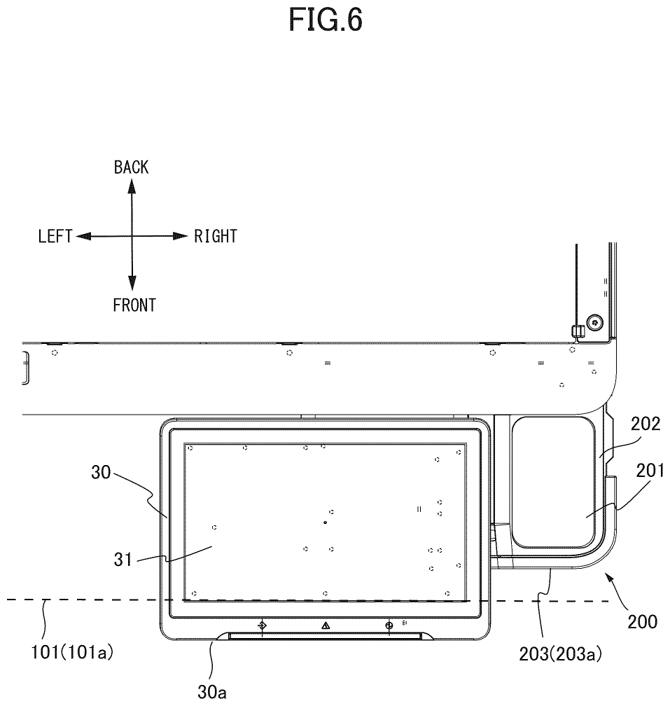

Next, with reference to FIG. 3, a configuration of the wireless communication unit 200 in this embodiment will be described using FIGS. 6 and 7. In FIGS. 6 and 7, to facilitate the understanding of the description, the illustration of the storage cover 204 is omitted. In addition, FIGS. 6 and 7 illustrate a case where the operation unit 30 is in a substantially horizontal state. The term “the substantially horizontal state of the operation unit 30” as referred to here includes a state in which the operation unit 30 is not tilted with respect to a horizontal plane perpendicular to the vertical direction (angle 0 degrees) and a state in which the operation unit 30 is tilted at an angle equal to or less than “+5 degrees”.

As illustrated in FIG. 6, when the operation unit 30 is in the substantially horizontal state, with respect to a front-back direction (a second direction intersecting with both the vertical direction and a first direction), a front edge 30a (second edge) on the same side as a front edge of the wireless communication unit 200 (specifically, a front edge 203a of the supporting portion 203, first edge) projects forward (outward) beyond the exterior surface 101a of the front cover 101, which is in the closed state. However, with the operation unit 30 tilted beyond the predetermined angle and at an angle greater than “+5 degrees” from the substantially horizontal state, the front edge 30a does not project forward beyond the exterior surface 101a of the front cover 101, which is in the closed state.

When viewed from above, the wireless communication unit 200 is disposed on the right side in the lateral direction (first direction) to be positioned adjacent to the operation unit 30. In this embodiment, to improve user usability, it is configured such that the user can operate the operation unit 30 with a left hand while presenting the IC card 300 to the wireless communication unit 200 with a right hand. The supporting portion 203 is configured to provide an installation space for the IC card reader 201 on the right side of the operation unit 30 so as to allow the user to conveniently present the IC card 300. When viewed from above, the IC card reader storage portion 202 is aligned in an overlapping manner with respect to this supporting portion 203, or, in other words, is supported so as not to project from the installation space that is established by the supporting portion 203. Within the IC card reader storage portion 202 supported on the installation space of the supporting portion 203, the IC card reader 201 is interchangeably stored.

As illustrated in FIG. 7, in the wireless communication unit 200, a front edge of the supporting portion 203, namely the front edge 203a in the front-back direction, projects forward (outward) beyond the exterior surface 101a of the front cover 101, which is in the closed state when viewed in the lateral direction. Since, as described above, the front cover 101 and the front upper cover 103 are arranged such that their respective exterior surfaces are substantially aligned to form a continuous plane when viewed from the lateral direction, the front edge 203a of the supporting portion 203 projects forward beyond the exterior surface 103a of the front upper cover 103 and the exterior surface of the cassette cover 102 (refer to FIG. 1). By projecting the front edge 203a of the supporting portion 203 forward as described above, even if the apparatus body 100A is miniaturized, it is possible to secure the installation space for mounting the IC card reader 201 on the front side of the apparatus body 100A. In addition, by projecting the front edge 203a of the supporting portion 203 forward, the user visibility of the position where the IC card reader 201 is located, namely the position for presenting the IC card 300, is enhanced. To be noted, the supporting portion 203 may be disposed integrally with the front upper cover 103 by configuring a lower surface 203b to form a smooth, continuous curved surface with the exterior surface 103a of the front upper cover 103.

In addition, in the wireless communication unit 200, the front edge 203a of the supporting portion 203 projects between the exterior surface 101a of the front cover 101, which is in the closed state when viewed from the lateral direction, and the front edge of the operation unit 30 in the substantially horizontal state, namely the front edge 30a in the front-back direction. For example, in the front-back direction, the front edge 203a of the supporting portion 203 is positioned “approximately 28 mm” forward from the exterior surface 101a of the front cover 101, and “approximately 27 mm” backward from the front edge 30a of the operation unit 30, which is in the substantially horizontal state. Generally, in a case where the image forming apparatus 100 is not in use, the operation unit 30 is frequently in the substantially horizontal state. Therefore, if part of the supporting portion 203 projects forward beyond the front edge 30a of the operation unit 30, the user is likely to find the supporting portion 203 obstructive. To avoid this, the supporting portion 203 is disposed such that the front edge 203a does not project forward (outward) beyond the front edge 30a of the operation unit 30, which is in the substantially horizontal state. On the other hand, in a case of using the image forming apparatus 100, the operation unit 30 is tilted from the substantially horizontal state to a state which the user desires for optimal operation. In that case, since the front edge 203a of the supporting portion 203 projects forward beyond the front edge 30a of the operation unit 30, the user can conveniently and visually confirm the position for presenting the IC card 300.

As described above, this embodiment provides the image forming apparatus 100, in which the wireless communication unit 200 is arranged on the apparatus body 100A in such a way that it is placed adjacent to the operation unit 30 when viewed from above. In the wireless communication unit 200, the front edge 203a of the supporting portion 203 projects forward beyond the exterior surface 101a of the front cover 101, which is in the closed state when viewed in the lateral direction. By projecting the front edge 203a of the supporting portion 203 forward as described above, even if the apparatus body 100A is miniaturized, it is possible to secure the installation space for mounting the IC card reader 201 on the front side of the apparatus body 100A. That is, instead of securing a separate space for mounting the IC card reader 201, which is an optional device, away from the operation unit 30 in conjunction with the miniaturization of the image forming apparatus 100, it is possible to secure the space adjacent to the operation unit 30, taking into account the user operability and visibility.

### OTHER EMBODIMENTS

To be noted, while, in the embodiment described above, the image forming apparatus 100 performs the personal verification using the IC card 300 and the IC card reader 201, it is not limited to this. For example, the image forming apparatus may acquire connection information for Wi-Fi (registered trademarks) communication by using mobile devices (portable information devices), such as smartphones and tablet computers, NFC tags, and the like via the NFC communication, and automatically set up the Wi-Fi communication. In this case, instead of the IC card reader 201, an NFC tag is stored in the IC card reader storage portion 202. Then, when the user brings a mobile devices compatible with the NFC communication close to the NFC tag, the image forming apparatus sets up the Wi-Fi communication by acquiring the connection information for the Wi-Fi communication from the mobile devices. Thereafter, the image forming apparatus can perform the data transmission and reception with the mobile devices through the Wi-Fi communication. In this way, the transmission and reception of large data volumes such as image data from the mobile devices is handed off to the Wi-Fi communication, so that the user can execute the image formation on the image forming apparatus using the mobile devices. Alternatively, the image formation based on the personal verification described above may be executed by the image forming apparatus using the mobile devices.

To be noted, while, in the embodiment described above, the operation unit 30 is the touch panel that includes the liquid crystal display screen 31, it is not limited to this. For example, the operation unit 30 is an operation panel that includes a hardware key and a liquid crystal display screen and is positioned on the front side of the apparatus body 100A facing the user during operation. The liquid crystal display screen and the hardware key are respectively exposed from a panel cover for user visibility and for user operation. In this case, in the wireless communication unit 200, the front edge 203a of the supporting portion 203 projects forward beyond a front edge of the panel cover of the operation panel when viewed in the lateral direction.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-092977, filed Jun. 7, 2024, hereby incorporated by reference herein in its entirety.

What is claimed is:

1. An image forming apparatus comprising:
an image forming unit configured to form an image on a recording material;
an apparatus body configured to store the image forming unit;
an operation unit that includes a display unit configured to display information relating to image formation and is configured to receive a user input operation;
a door that includes an exterior surface constituting part of a front side of the apparatus body on a lower side of the operation unit in a case where the front side is a side facing a user during an operation of the operation unit in a front-back direction, the door being configured to move between a closed position and an open position in which the user is allowed access to an interior of the apparatus body; and
a wireless communication unit configured to receive data from a portable information device via near field wireless communication (NFC) in response to the portable information device being presented,
wherein, in a case where a lateral direction is a direction perpendicular to the front-back direction of the image forming apparatus and a vertical direction, the wireless communication unit is arranged above the door to align with the operation unit in the lateral direction, and a front edge of the wireless communication unit in the front-back direction projects forward beyond the exterior surface of the door which is in the closed position.

2. The image forming apparatus according to claim 1,
wherein a front edge of the operation unit in the front-back direction projects forward beyond the exterior surface of the door which is in the closed position, and
wherein the front edge of the wireless communication unit is positioned between the exterior surface of the door, which is in the closed position, and the front edge of the operation unit in the front-back direction.

3. The image forming apparatus according to claim 2,
wherein the operation unit is configured to pivot vertically with respect to the apparatus body, with the lateral direction as a pivot axis direction, and
wherein, when the operation unit is in a substantially horizontal state with respect to a horizontal plane perpendicular to the vertical direction, the wireless communication unit projects such that the front edge of the wireless communication unit is positioned between the exterior surface of the door, which is in the closed position when viewed from the lateral direction, and the front edge of the operation unit.

4. The image forming apparatus according to claim 1,
wherein the operation unit includes a touch panel that is configured to display a software key and is configured to receive the information relating to the image formation through a touch operation of the user with respect to the software key.

5. The image forming apparatus according to claim 1,
wherein the wireless communication unit includes an acquisition unit configured to acquire data from the portable communication device in response to the portable communication device being presented, a storage portion configured to store the acquisition unit interchangeably, and a supporting portion configured to support the storage portion.

6. The image forming apparatus according to claim 5,
wherein the portable information device includes an integrated circuit (IC) card, and
wherein the acquisition unit includes a contactless type IC card reader that is configured to acquire the data from the IC card via NFC communication.

7. The image forming apparatus according to claim 6,
wherein the wireless communication unit further includes a cover member that is openably and closably disposed to the storage portion and is configured to cover the IC card reader in a closed state.
